(19) United States
(12) Patent Application Publication
(10) Pub. No.: US 2015/0377199 A1
(43) Pub. Date: Dec. 31, 2015

(54) METHOD FOR VENTING A FUEL SUPPLY LINE, AND INTERNAL COMBUSTION ENGINE

(71) Applicant: MTU FRIEDRICHSHAFEN GMBH, Friedrichshafen (DE)

(72) Inventors: Marc RADL, Friedrichshafen (DE); Klaus REISCHMANN, Wangen (DE); Michael WILLMANN, Bermatingen (DE)

(73) Assignee: MTU Friedrichshafen GmbH, Friedrichshafen (DE)

(21) Appl. No.: 14/773,979

(22) PCT Filed: Mar. 5, 2014
(86) PCT No.: PCT/EP2014/000556

§ 371 Date: Sep. 9, 2015

(30) Foreign Application Priority Data
Mar. 11, 2013 (DE) 10 2013 204 093.8

(51) Int. Cl. F02M 55/00; F02D 41/06; F02D 41/38; F02M 55/02

(52) U.S. Cl. CPC F02M 55/007; F02M 55/025; F02D 41/06; F02D 41/3845

(57) ABSTRACT

A method for venting a fuel supply line of a direct-injection internal combustion engine, wherein the fuel supply line has an injector, a high-pressure accumulator upstream of the injector, a flow rate limiting valve between the high-pressure accumulator and the injector for the purposes of limiting a fuel flow rate passing from the high-pressure accumulator to the injector, and a high-pressure pump upstream of the high-pressure accumulator for delivering fuel into the high-pressure accumulator. A pressure in the high-pressure accumulator is regulated by an intake throttle arranged upstream. of the high-pressure pump. In this case, it is provided that the fuel supply line is vented downstream of the high-pressure pump, wherein, during venting operating mode, a passage cross section for the fuel which is smaller than or equal to a predetermined threshold passage cross section is set in the intake throttle.

The invention relates to a method for venting a fuel supply line as per the preamble of claim 1 and to an internal combustion engine having a direct injection system as per the preamble of claim 9.

Methods and internal combustion engines of the type discussed here are known. A direct injection system of an internal combustion engine typically has at least one injector by means of which fuel is injected into a combustion chamber of the internal combustion engine. A fuel supply line is provided via which fuel can be supplied to the injector. Upstream of the injector there is provided a high-pressure accumulator which is referred to as a so-called common rail. If the internal combustion engine has multiple injectors, these are preferably all supplied with fuel from the common high-pressure accumulator. A high-pressure pump is provided for the delivery of fuel into the high-pressure accumulator. A pressure in the high-pressure accumulator is regulated by means of an intake throttle arranged upstream of the high-pressure pump. To prevent the internal combustion engine being damaged as a result of an inadmissible supply of fuel through a defective injector which no longer correctly closes, there is arranged between the high-pressure accumulator and the injector a flow rate limiting valve which limits a fuel flow rate passing from the high-pressure accumulator to the injector. If the injector malfunctions, such that there is a tendency for an excessive amount of fuel to flow into the combustion chamber, the flow rate limiting valve reacts and shuts off the fluidic connection between the high-pressure accumulator and the defective injector.

Upon an initial start of the internal combustion engine or after maintenance or repair, it may be the case that the fuel supply line is aerated, in particular downstream of the flow rate limiting valve. In this case, upon starting of the internal combustion engine, the air in the fuel supply line is compressed. Since it is necessary here for a large air volume to be displaced, a large amount of fuel flows via the flow rate limiting valve during the filling of the aerated fuel supply line. Said flow rate limiting valve may react in an undesired manner as a result. The injector which is assigned to the flow rate limiting valve will thereupon be supplied with only a low fuel flow rate, or with no fuel flow rate whatsoever. This leads to reduced performance and to uneven running of the internal combustion engine. It may then be necessary for said internal combustion engine to be completely shut down, and for the fuel supply line to be ventilated, several times. DE 103 42 116 B4 has disclosed a method for ventilating a fuel injection line, in which method an injector is held open for very much longer during venting operating mode than during the normal injection operating mode. In this way, a flow of air out of the fuel injection line into cylinders of the internal combustion engine is made possible. In this case, too, it may however still be the case that a flow rate limiting valve arranged upstream of the injector inadmissibly reacts, giving rise to the problems already described above.

The invention is therefore based on the object of providing a method and an internal combustion engine which do not have the described disadvantages, wherein in particular, venting of the fuel supply line should be possible, with inadmissible reaction of a flow rate limiting valve being prevented.

The object is achieved through the provision of a method having the steps of claim 1.

The method is characterized in that the fuel supply line is vented downstream of the high-pressure pump, wherein, during venting operating mode, a passage cross section for the fuel which is smaller than or equal to a predetermined threshold passage cross section is set in the intake throttle. The threshold passage cross section is at any rate smaller than a maximum passage cross section of the intake throttle, preferably smaller than a passage cross section typically assumed during a normal operating mode of the internal combustion engine. This thus results in a reduced delivery flow from the high-pressure pump during venting operating mode, such that only a small volume flow is delivered, which can correspondingly pass via the at least one flow rate limiting valve. Said flow rate limiting valve therefore does not inadmissibly react, and the fuel supply line is reliably vented and filled with fuel. The air in the fuel supply line is compressed and, during subsequent engine running, dissolves or is discharged into a combustion chamber of the internal combustion engine. An inadmissible reaction of the flow rate limiting valve is accordingly prevented by virtue of a reduced fuel flow being delivered by means of the high-pressure pump during venting operating mode.

A method is also preferred which is characterized in that the venting operating mode is performed upon starting of the internal combustion engine. The venting operating mode is preferably performed upon initial starting of the internal combustion engine. It is alternatively or additionally provided that the venting operating mode is performed after maintenance or repair of the internal combustion engine. In particular, the venting operating mode is performed if the fuel supply line has been aerated downstream of the high-pressure accumulator. A sensor means is preferably provided, with the aid of which it is detected, in particular upon starting, whether the fuel supply line downstream of the high-pressure accumulator has been aerated. If this is detected, the ventilation operating mode is implemented upon starting of the internal combustion engine. By contrast, if no aeration of the fuel supply line is detected, the internal combustion engine is preferably started in a normal start-up operating mode. In this case, in the normal start-up operating mode, it is preferably the case that the passage cross section of the intake throttle is set to a maximum value in order that a predetermined pressure is attained in the high-pressure accumulator as rapidly as possible. The ventilation operating mode is accordingly distinguished from the normal start-up operating mode specifically by the fact that, contrary to the conventional approach, in which it is sought to attain a predetermined pressure in the high-pressure accumulator as rapidly as possible by maximizing the delivery of fuel, the passage cross section of the fuel is limited in the region of the intake throttle in order to limit the fuel flow to a value at which the flow rate limiting valve does not inadmissibly react.

A method is preferred which is characterized in that the intake throttle is actuated by an engine control unit of the internal combustion engine. In the engine control unit there is preferably implemented an algorithm by means of which the pressure in the high-pressure accumulator can be controlled and/or regulated during the normal operating mode of the internal combustion engine, wherein, during a normal start-up operating mode of the internal combustion engine, the passage cross section of the intake throttle is preferably maximized, that is to say the intake throttle is fully opened, in order that the predetermined pressure is attained as rapidly as possible. In the engine control unit there is furthermore preferably implemented an algorithm which makes it possible to implement the venting operating mode, wherein, in said venting operating mode, the passage cross section of the intake throttle is set to be smaller than or equal to the predetermined threshold passage cross section. The engine control unit is preferably operatively connected to the intake throttle for actuation purposes.

A method is also preferred which is characterized in that the venting operating mode is ended when the fuel supply line has been vented. The venting operating mode is preferably ended by virtue of the intake throttle being actuated—preferably by the engine control unit—for the purposes of regulating the pressure in the high-pressure accumulator. Thus, to end the venting operating mode, the actuation of the intake throttle is changed, wherein said intake throttle is no longer held in a position for a passage cross section smaller than or equal to the predetermined threshold passage cross section, but is actuated such that regulation of the pressure in the high-pressure accumulator is performed. After the venting operating mode has been purposely implemented, a switch is accordingly preferably made to a normal operating mode of the internal combustion engine. The end of the venting operating mode is preferably detected by the sensor means, by means of which it can be detected whether the fuel supply line downstream of the high-pressure accumulator is aerated.

A method is preferred which is characterized in that the predetermined threshold passage cross section is selected to be 50%, preferably 25%, preferably 15%, preferably 10%, preferably 5%, preferably 2%, preferably 1% of a maximum passage cross section of the intake throttle. Here, the intake throttle is preferably designed such that its passage cross section is variable in stepped or preferably continuous fashion between a minimum passage cross section and a maximum passage cross section. Through corresponding selection of the threshold passage cross section, it is ensured that, during the venting operating mode, a flow of fuel delivered by the high-pressure pump is only such that the flow rate limiting valve does not inadmissibly react. In this case, it may be provided that the predetermined threshold passage cross section, which is preferably stored in the engine control unit, is selected in a manner dependent on a flow rate limiting valve used in the internal combustion engine. This approach is based on the concept that different flow rate limiting valves react at different values of a fuel flow passing across it, such that preferably, the threshold passage cross section is coordinated with a specifically installed flow rate limiting valve. In particular, the predetermined threshold passage cross section is preferably coordinated with the specifically used intake throttle and with a specifically used flow rate limiting valve, such that it is ensured that, during the venting operating mode, no inadmissibly high volume flow passes across the flow rate limiting valve, such that a reaction of said flow rate limiting valve is prevented.

A method is also preferred which is characterized in that an engine speed of the internal combustion engine is kept at approximately 100 rpm (revolutions per minute) during the venting operating mode. Said value preferably lies below an idle speed of the internal combustion engine. In this way, the delivery flow from the high-pressure pump is additionally reduced, which is advantageous for the venting operating mode.

A method is also preferred which is characterized in that a pressure downstream of the flow rate limiting valve is detected. For this purpose, a pressure sensor is preferably provided in the fuel supply line downstream of the flow rate limiting valve. Said pressure sensor is preferably operatively connected to the engine control unit, such that said engine control unit can evaluate the pressure detected by the pressure sensor and use said pressure for the control of the internal combustion engine.

It is preferably the case that—in particular in the engine control unit—determination of whether the fuel supply line has been vented is performed on the basis of the detected pressure. In this case, it is possible by means of the measurement values provided by the pressure sensor to reach a decision as regards whether a venting operating mode should be performed upon starting of the internal combustion engine, or whether and when the venting operating mode should be ended.

A method is also preferred which is characterized in that the high-pressure pump is driven at the engine speed by the internal combustion engine. The high-pressure pump is in this case operatively connected directly to the internal combustion engine such that the high-pressure pump rotates at the same speed as the internal combustion engine in all operating states. Specifically in this refinement, it is advantageous if the pressure in the high-pressure accumulator is regulated by means of the intake throttle, because the delivery rate of the high-pressure pump varies in a manner dependent on the speed of the internal combustion engine.

The object is also achieved through the provision of an internal combustion engine having the features of claim 9. Said internal combustion engine comprises a direct-injection system which has at least one injector for injecting fuel into a combustion chamber of the internal combustion engine. Upstream of the injector, there is provided a high-pressure accumulator which is fluidically connected to the injector for the purposes of supplying fuel to the injector. A flow rate limiting valve is arranged in the fluidic connection between the high-pressure accumulator and the injector for the purposes of limiting a fuel flow rate passing from the engine accumulator to the injector. A high-pressure pump for delivering fuel into the high-pressure accumulator is provided upstream of the latter, wherein a pressure in the high-pressure accumulator can be regulated, upstream of the high-pressure pump, by way of an intake throttle. The intake throttle can be actuated by an engine control unit of the internal combustion engine. The internal combustion engine is characterized in that the engine control unit is set up for carrying out a method according to one of the embodiments described above. This yields the advantages that have already been discussed in conjunction with the method.

It is possible, in one exemplary embodiment of the internal combustion engine, for the intake throttle to be integrated into the high-pressure pump. The statement that the intake throttle is provided upstream of the high-pressure pump refers in particular to the functional arrangement of the intake throttle, and means that the intake throttle limits the flow of fuel to the high-pressure pump. It is alternatively also possible for the intake throttle to be arranged, as a separate element, in the fuel supply line upstream of the high-pressure pump.

An internal combustion engine is also preferred which is characterized in that the at least one injector has an internal fuel accumulator. Said internal fuel accumulator does not replace the high-pressure accumulator but is provided in addition thereto.

In one exemplary embodiment of the internal combustion engine, it is also possible for the flow rate limiting valve to be integrated into the injector. In another exemplary embodiment, it is provided that the flow rate limiting valve is provided as a separate element upstream of the injector.

The description of the method, on the one hand, and of the internal combustion engine, on the other hand, are to be understood as being complementary to one another. In particular, an internal combustion engine is preferred which is characterized by at least one feature entailed by at least one method step, preferably combinations thereof, of an embodiment of the method. Conversely, a method is preferred which is characterized by at least one method step arising from at least one feature of the internal combustion engine, preferably combinations thereof. All the features described in conjunction with the method are preferably features, individually or in combination with one another, of an exemplary embodiment of the internal combustion engine. Likewise, all of the method steps described in conjunction with the internal combustion engine are preferably steps, individually or in combination with one another, of an embodiment of the method.

The invention will be discussed in more detail below on the basis of the drawing, in which the single

FIGURE is a schematic illustration of an exemplary embodiment of a direct-injection system of an internal combustion engine.

The FIGURE is a schematic illustration of a direct injection system 1 of an exemplary embodiment of an internal combustion engine. The direct injection system 1 has an injector 3 by means of which, with the aid of a schematically illustrated valve device 5, fuel 7 can be injected into a combustion chamber (not illustrated) of the internal combustion engine. In the exemplary embodiment illustrated, the injector 3 furthermore comprises an internal fuel accumulator 9.

A fuel supply line 11 serves for delivering fuel from a fuel reservoir 13, preferably a tank, to the injector 3. Arranged upstream of the injector 3 there is a high-pressure accumulator 15 from which fuel is supplied to the injector 3. Between the high-pressure accumulator 15 and the injector 3, a flow rate limiting valve 17 is arranged in the fuel supply line 11 in order to protect the internal combustion engine against an inadmissibly high fuel flow rate that could be introduced into the combustion chamber via a defective injector 3. The functioning of the flow rate limiting valve 17 will be discussed in more detail below.

For the delivery of fuel into the high-pressure accumulator 15, a high-pressure pump 19 is arranged in the fuel line 11 upstream of said high-pressure accumulator. The delivery rate of said high-pressure pump is controlled by way of an intake throttle 21 arranged upstream of the high-pressure pump 19, wherein in particular, the pressure in the high-pressure accumulator 15 is regulated by means of the intake throttle 21. The intake throttle 21 is in this case illustrated schematically as a valve device which is separate from the high-pressure pump 19. It is however very much possible for the intake throttle 21 to be formed as part of, or integrated into, the high-pressure pump 19. A passage cross section of the intake throttle 21 is preferably continuously variable between a minimum value and a maximum value. It is possible for the minimum value of the passage cross section to correspond to a closed position of the intake throttle 21, such that in this case, no fuel can be delivered via the intake throttle 21.

In the illustrated exemplary embodiment, there is provided upstream of the intake throttle 21 a low-pressure pump 23 which serves for delivering fuel from the reservoir 13 to the intake throttle 21 via a filter 25.

In the illustrated exemplary embodiment, the flow rate limiting valve 17 has a throughflow limiting device 27 and, arranged downstream of the latter, a compensation volume 29, wherein the compensation volume 29 preferably comprises a throttle device 31. In the exemplary embodiment illustrated, the throughflow limiting device 27 comprises a piston 35 which is displaceable in a cylinder 33 and which is preloaded by a spring element 37 into the position denoted by A. A fixed throttle 39 schematically indicates that a predetermined passage cross section for fuel is provided in the region of the piston 35. In this case, it is possible for the fuel to flow through a bore in the piston 35—as indicated by the fixed throttle 39 in the FIGURE. In another exemplary embodiment, it is possible for the fuel to flow laterally past the piston 35. Other embodiments for realizing the function of the fixed throttle 39 are also possible.

The piston 35 is displaceable, counter to the preload force of the spring element 37, from its stop position illustrated at A to a stop position illustrated at C via a middle position illustrated at B.

In the stop position C, it is no longer possible for fuel to flow via the fixed throttle 39. In this case, the flow rate limiting valve 17 is arranged in a blocking position, such that fuel can no longer flow from the high-pressure accumulator 15 to the injector 3.

During a normal operating mode of the internal combustion engine, the fuel supply line 11 is completely filled with substantially incompressible fuel. The pressure in the high-pressure accumulator 15 is regulated by means of the intake throttle 21. When the valve device 5 of the injector 3 is closed, no fuel flows from the high-pressure accumulator 15 via the flow rate limiting valve 17 to the injector 3. When an injection of fuel 7 into the combustion chamber assigned to the injector 3 is performed by means of the injector 3, fuel 7 flows out via the valve device 5, resulting at the same time in a flow of fuel from the high-pressure accumulator 15 to the injector 3 via the flow rate limiting valve 17. In this case, if more fuel 7 is discharged via the valve device 5 per unit of time than can flow in through the fixed throttle 39, this is compensated by virtue of the compensation volume 29 being reduced, wherein the piston 35 is displaced—in the FIGURE—to the right, counter to the preload force of the spring element 37. During the normal operating mode, the injection typically ends when the piston approximately reaches its position illustrated at B. Since, at this time, the valve device 5 closes, such that no further injection of fuel takes place, it is then the case that a compensation flow takes place from the high-pressure accumulator 15 via the fixed throttle 39 into the internal accumulator 9, because the pressure downstream of the fixed throttle 39 has decreased in relation to the pressure level of the high-pressure accumulator 15 during the injection event and during the displacement of the piston 35. During the pressure compensation, the piston 35 is displaced back from the position B into the position A, into which said piston is forced by the spring element 37.

If, owing to a malfunction of the injector 3, the valve device 5 does not close or does not close at the correct time, the pressure in the internal accumulator 9 or in the fuel supply line 11 downstream of the flow rate limiting valve 17 decreases further, and the compensation volume 29 is further reduced, by virtue of the piston 35 being displaced—in the FIGURE—to the right beyond the position B. Specifically, it is not possible for enough fuel to flow per unit of time through the fixed throttle 39 in order to compensate for the outflow of fuel via the valve device 5. If the injection continues for longer, the piston 35 finally reaches the position illustrated at C, in which the fluidic connection between the high-pressure accumulator 15 and the injector 3 is blocked. It is then no longer possible for fuel to flow in from the high-pressure accumulator 15, such that the compensation volume 29, if appropriate the internal accumulator 9, and the injector 3 are evacuated into the combustion chamber. As a result, the pressure in the region of the injector 3 falls, such that the piston 35 is permanently held in the blocking position illustrated at C by the pressure difference between the high-pressure accumulator 15, on the one hand, and the injector 3, on the other hand. The flow rate limiting valve 17 is therefore permanently blocked, and no inadmissible fuel flow rate can be introduced into the combustion chamber via the defective injector 3. In this way, the internal combustion engine is protected against damage resulting from an excessive amount of energy.

If, upon an initial start of the internal combustion engine or after maintenance or repair, the fuel supply line 11 as a whole, or at any rate downstream of the flow rate limiting valve 17, is aerated, the following problem arises: upon starting of the internal combustion engine, the high-pressure pump 19 delivers fuel into the high-pressure accumulator 15, and onward from the latter via the fixed throttle 39 into the compensation volume 29 and to the injector 3. Typically, the passage cross section of the intake throttle 21 is, during a normal start-up operating mode of the internal combustion engine, set to a maximum in order that a predetermined pressure is attained in the high-pressure accumulator 15 as rapidly as possible. Since the fixed throttle 39 constitutes a flow obstruction, there is a pressure drop across the piston 35. If the compensation volume 29 is now in an aerated state, that is to say filled with a compressible medium, in particular air, the piston 35, owing to the pressure difference, moves rapidly—in the FIGURE—to the right counter to the preload force of the spring element 37, wherein the fuel volume that flows in via the fixed throttle 39 per unit of time is not sufficient to compensate for the compression in the compensation volume 29. There is therefore the risk of the piston 35 reaching the position illustrated at C, whereby the flow rate limiting valve 17 reacts and the fluidic connection between the high-pressure accumulator 15 and the injector 3 is permanently blocked. An injection through the injector 3 is then no longer possible. This leads to a performance deficiency and/or uneven running of the internal combustion engine. It is then necessary, under some circumstances, for the internal combustion engine to be completely shut down, and for the fuel supply line 11 upstream of the flow rate limiting valve 17 to be ventilated, several times, because otherwise it is not possible for the piston 35 to be displaced back into the position A.

By means of the method according to the invention and the internal combustion engine according to the invention, this problematic situation can be avoided. During a venting operating mode, the intake throttle 21 is actuated so as to have only a passage cross section which is smaller than or equal to a predetermined threshold passage cross section. In this case, the threshold passage cross section is preferably smaller than a passage cross section typically assumed by the intake throttle 21 during the normal operating mode of the internal combustion engine, and in particular smaller, preferably very much smaller, than the maximum passage cross section assumed during normal start-up of the internal combustion engine. In this way, the fuel flow rate delivered by the high-pressure pump 19 is limited, such that the fuel supply line 11 upstream of the high-pressure pump 19 is slowly filled with fuel.

It is particularly preferably the case that, during the venting operating mode, the passage cross section of the intake throttle 21 is set such that the fuel flow rate delivered by the high-pressure pump 19 specifically corresponds, up to the end of the venting operating mode, to the volume flow passing through the fixed throttle 39.

In another embodiment of the method, the passage cross section of the intake throttle 21 during the venting operating mode is preferably selected such that the piston does not move in the direction of its stop position illustrated at C, or moves in the direction of its stop position illustrated at C only very slowly, or at most only so rapidly that the venting of the fuel supply line 11 is completed before the piston 35 reaches its blocking position. It is ensured in this way that the piston 35 does not reach its blocking position during the venting. When the venting is complete, the pressure in the high-pressure accumulator 15 and the pressure downstream of the flow rate limiting valve 17, in particular in the internal fuel accumulator 9, equalize via the fixed throttle 39. The piston 35, driven by the restoring force of the spring element 37, moves back into its position illustrated at A. A normal operating mode of the internal combustion engine is then possible; in particular, it is then possible for the pressure in the high-pressure accumulator 15 to be regulated by way of the intake throttle 21.

The speed of the internal combustion engine is preferably kept at approximately 100 rpm during the venting operating mode. After the venting operating mode is ended, said speed is preferably increased to an idle speed which is for example approximately 350 rpm. By virtue of the high-pressure pump 19 preferably being driven at the speed of the internal combustion engine, with said speed preferably being reduced during the venting operating mode, the delivery rate of the high-pressure pump 19 is limited in addition to the actuation of the intake throttle 21, which makes the venting operating mode particularly reliable.

Altogether, by means of the method and the internal combustion engine, it is possible for an undesired reaction of the flow rate limiting valve 17 during the venting of the fuel supply line 11 to be prevented.

1-10. (canceled)

11. A method for venting a fuel supply line of a direct-injection internal combustion engine, wherein the fuel supply line has an injector, a high-pressure accumulator upstream of the injector, a flow rate limiting valve between the high-pressure accumulator and the injector for limiting a fuel flow rate passing from the high-pressure accumulator to the injector, and a high-pressure pump upstream of the high-pressure accumulator for delivering fuel into the high-pressure accumulator, the method comprising the steps of: regulating a pressure in the high-pressure accumulator by an intake throttle arranged upstream of the high-pressure pump; venting the fuel supply line downstream of the high-pressure pump, wherein, during a venting operating mode, a passage cross section for the fuel which is smaller than or equal to a predetermined threshold passage cross section is set in the intake throttle.

12. The method as claimed in claim 11, including implementing the venting operating mode upon starting of the internal combustion engine.

13. The method as claimed in claim 12, including implementing the venting operating mode upon an initial start or after maintenance or repair of the internal combustion engine.

14. The method as claimed in claim 13, including implementing the venting operating mode when the fuel supply line has been aerated downstream of the high-pressure accumulator.

15. The method as claimed in claim 11, including actuating the intake throttle by an engine control unit of the internal combustion engine.

16. The method as claimed in claim 11, including ending the venting operating mode when the fuel supply line has been vented.

17. The method as claimed in claim 16, wherein the venting operating mode is ended by virtue of the intake throttle being actuated for regulating the pressure in the high-pressure accumulator.

18. The method as claimed in claim 11, including selecting the predetermined threshold passage cross section to be 50% of a maximum passage cross section of the intake throttle.

19. The method as claimed in claim 18, including selecting the predetermined threshold passage cross section to be 25% of the maximum passage cross section of the intake throttle.

20. The method as claimed in claim 19, including selecting the predetermined threshold passage cross section to be 15% of the maximum passage cross section of the intake throttle.

21. The method as claimed in claim 20, including selecting the predetermined threshold passage cross section to be 10% of the maximum passage cross section of the intake throttle.

22. The method as claimed in claim 21, including selecting the predetermined threshold passage cross section to be 5% of the maximum passage cross section of the intake throttle.

23. The method as claimed in claim 22, including selecting the predetermined threshold passage cross section to be 2% of the maximum passage cross section of the intake throttle.

24. The method as claimed in claim 23, including selecting the predetermined threshold passage cross section to be 1% of the maximum passage cross section of the intake throttle.

25. The method as claimed in claim 11, including maintaining engine speed of the internal combustion engine at about 100 rpm during the venting operating mode.

26. The method as claimed in claim 11, including detecting a pressure downstream of the flow rate limiting valve, and determining whether the fuel supply line has been vented based on the detected pressure.

27. The method as claimed in claim 11, including driving the high-pressure pump at the engine speed by the internal combustion engine.

28. An internal combustion engine, comprising: a combustion chamber; a direct-injection system having at least one injector for injecting fuel into the combustion chamber, a high-pressure accumulator arranged upstream of the injector and fluidically connected to the injector for supplying fuel to the injector, a flow rate limiting valve arranged in the fluidic connection between the high-pressure accumulator and the injector for limiting a fuel flow rate passing from the high-pressure accumulator to the injector, and a high-pressure pump provided upstream of the high-pressure accumulator for delivering fuel into the high-pressure accumulator, an intake throttle provided upstream of the high-pressure pump for regulating a pressure in the high-pressure accumulator; and an engine control unit for actuating the intake throttle, the engine control unit being set up to carry out the method as claimed in claim 11.

29. The internal combustion engine as claimed in claim 28, wherein the at least one injector has an internal fuel accumulator.
